(19) United States
(12) Patent Application Publication
(10) Pub. No.: US 2017/0341675 A1
(43) Pub. Date: Nov. 30, 2017

(54) METHOD AND APPARATUS FOR PROVIDING A SLED FOR ICE BLOCKING

(71) Applicant: Max James-Jolly, Long Beach, CA (US)

(72) Inventor: Max James-Jolly, Long Beach, CA (US)

(21) Appl. No.: 15/400,952

(22) Filed: Jan. 6, 2017

Related U.S. Application Data
(63) Continuation of application No. 62/342,939, filed on May 28, 2016.

(51) Int. Cl. B62B 15/00; F25C 1/04; F25C 1/22; F25C 3/00

(52) U.S. Cl. CPC B62B 15/00; F25C 3/00; F25C 1/04; F25C 1/22

(57) ABSTRACT

Ice block mold for ice blocking which integrally mates to a handled surface giving rise to an ice blocking sled. The ice mold is filled with water. The seat is placed on top and the mold filled with water and the seat on top are placed in a freezer and frozen together. The ice mold is shaped like a sled. The components work together by the user filling the ice mold with water and places the seat on top and freezes both objects together. Once frozen, the mold is removed and what is left is the seat attached to the ice block via the ice anchors built into the seat. The seat and frozen ice can then be used to slide down hills with the seat providing a barrier between the ice and user as well as providing handles for the use.

### RELATED APPLICATIONS

This application is related and claims priority to U.S. Provisional Application No. 62/342,939 entitled, “METHOD AND APPARATUS FOR PROVIDING A SLED FOR ICE BLOCKING” filed on May 28, 2016, which is hereby incorporated by reference in its entirety.

### TECHNICAL FIELD

The present invention generally relates to providing a recreational sled device. Aspects of the disclosure are directed to apparatus and methods for conveniently creating a multi-seasonal ice blocking sled. Specifically, an ice block mold integrally mates to a handled surface giving rise to an ice blocking sled.

### BACKGROUND

Traditionally snow-covered inclines are frequently used for recreational enjoyment. Children and adults alike employ sleds, inner tubes, toboggans, and other similar devices to slide down them. Such devices enable one or more users to sit or lie down on the device while sliding down a snow-covered incline. Other devices, such as skis and snowboards, exist that are configured to enable users to stand while sliding down a snow-covered incline.

While the devices that are currently available provide enjoyment of sliding down a snow-covered incline, the absence of snow prevents such enjoyment. Therefore, such enjoyment is restricted to the winter months and to locations where snow falls.

In order to provide similar enjoyment during summer months and/or in areas where snow is not located, a variety of techniques and devices are available. For example, consumers are able to utilize skies that are designed for use on a grassy ski slope. Also, individuals utilize a block of ice to slide down a grassy hill. This recreational sport is commonly referred to as “ice blocking.”

Ice blocking is a recreational activity in which individuals race to the bottom of a hill sitting on large blocks of ice. At minimum, ice blocking equipment typically comprises large blocks of thick ice and clothing—preferably padded—to cover the blocks. Hessian sacks or old towels are also used to sit on. The ice block is carried by a user up a hill and placed on the ground. The towel is placed on top of the ice block to provide a seat for the user. The user sits on top of the towel and slides down the incline of the hill.

While the ice blocking technique enables a user to slide down an incline, the user typically experiences several undesirable conditions. For example, because of the cold temperature of the ice block, the towel is commonly used to carry the block up the hill. As such, the towel becomes wet. The towel further becomes wet from continued use and thus provides an undesirable seat for the user.

Another problem with current techniques is that the ice block has the tendency to escape from under the towel and/or the user. As such, the user can become wet, dirty and/or injured in the process. Therefore, young children may not participate in the recreational activity because of the risk of injury.

Thus, while techniques currently exist that enable a user to slide down an incline, challenges still exist. Accordingly, it would be an advancement in the art to augment or even replace current techniques while retaining the spirit and fun of the recreation.

What is needed are new methods and apparatus that make it both safer and more convenient for individuals to ice block during any season of the year. A more comprehensive discussion of the features and advantages of the present invention is deferred to the following detailed description, which proceeds with reference to the accompanying drawings.

The present disclosure contemplates a novel ice blocking apparatus and method of making thereof comprising a device for fabricating an ice blocking sled, as well as practical methods for the application thereof and remedying these and/or other associated problems.

This overview is intended to provide an overview of subject matter of the present patent application. It is not intended to provide an exclusive or exhaustive explanation of the invention. Further limitations and disadvantages of conventional and traditional approaches will become apparent to one of skill in the art, through comparison of such systems with some aspects of the present invention as set forth in the remainder of the present application with reference to the drawings.

### SUMMARY

The present invention is discloses apparatuses and methods for providing a recreational sled device. Aspects of the disclosure are directed to apparatus and methods for conveniently creating a multi-seasonal ice blocking sled. Specifically, an ice block mold integrally mates to a handled surface giving rise to an ice blocking sled.

Objects of the invention are to provide a sled of simple structure which is inexpensive in manufacture and is produced with facility, convenience and rapidity, and functions as a sled to permit a rider to slide down a hillside or dune completely devoid of snow and/or ice. This permits all types of sledding activities under conditions of warm weather and total lack of snow, and is therefore a source of considerable amusement, enjoyment, exercise and recreation.

It is an object of this invention to provide a very simple and yet efficient and highly entertaining device to be used for coasting. It is a further object of the invention to provide a coasting device in the form of a pan or tray which integrally mates to a seating surface, said seating preferably being equipped with handholds for the use of the occupant.

While the methods and processes of the present invention have proven to be particularly useful in the area of providing a surface for a user to sit thereon, those skilled in the art can appreciate that the methods and processes can be used in a variety of different applications and in a variety of different areas of manufacture to yield a variety of different devices that may be marketed for sliding down an incline, including devices that allow a user to lie, kneel, or stand on while sliding. Moreover, those skilled in the art will appreciate that the methods and processes of the present invention embrace utilization of a multi-seasonal sliding mechanism for ice block sledding.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

For a fuller understanding of the nature and advantages of the present invention, reference is made to the following detailed description of preferred embodiments and in connection with the accompanying drawings, in which:

FIG. 1 is an isometric perspective of an exemplary sled mold enclosure, in accordance with some embodiments of the disclosure provided herein;

FIG. 2 is an exploded, isometric perspective of an exemplary sled mold enclosure comprising top handle assembly and bottom ice mold, in accordance with some embodiments of the disclosure provided herein;

FIG. 3 is an isometric perspective of an exemplary sled mold enclosure depicting a transparent/cut-away view of internals thereof, in accordance with some embodiments of the disclosure provided herein;

FIG. 4 is a disjointed, side-view of an exemplary sled mold enclosure, in accordance with some embodiments of the disclosure provided herein;

FIG. 5 is a disjointed, front view of an exemplary sled mold enclosure, in accordance with some embodiments of the disclosure provided herein;

FIG. 6 is an isometric perspective of an exemplary sled mold enclosure, in accordance with one or more alternate embodiments of the disclosure provided herein;

FIG. 7 is an isometric perspective of an exemplary sled mold enclosure as viewed from the bottom, in accordance with one or more alternate embodiments of the disclosure provided herein;

FIG. 8 is a front view of an exemplary sled mold enclosure, in accordance with one or more alternate embodiments of the disclosure provided herein;

FIG. 9 is a front view of an exemplary sled mold enclosure, in accordance with one or more alternate embodiments of the disclosure provided herein;

FIG. 10 is a side view of an exemplary sled mold enclosure, in accordance with one or more alternate embodiments of the disclosure provided herein;

FIG. 11 is a rear view of an exemplary sled mold enclosure, in accordance with one or more alternate embodiments of the disclosure provided herein;

FIG. 12 is a three quarter view of an exemplary sled mold enclosure, in accordance with one or more alternate embodiments of the disclosure provided herein;

FIG. 13 is an isometric perspective of an exemplary top handle assembly of a sled mold enclosure as viewed from the bottom, in accordance with one or more embodiments of the disclosure provided herein;

FIG. 14 is an exploded, isometric perspective of an exemplary sled mold enclosure comprising top handle assembly and bottom ice mold, in accordance with one or more alternate embodiments of the disclosure provided herein;

FIG. 15 is an isometric perspective of a sled mold enclosure, in accordance with some of the embodiments of the disclosure provided herein;

FIG. 16 is an isometric perspective of a sled mold enclosure as viewed from the three quarter rear, in accordance with some of the embodiments of the disclosure provided herein;

FIG. 17 is an isometric perspective of a bottom ice mold of a sled mold enclosure, in accordance with some of the embodiments of the disclosure provided herein;

FIG. 18 is an upside down isometric perspective of a bottom ice mold of a sled mold enclosure, in accordance with some of the embodiments of the disclosure provided herein;

FIG. 19 is an isometric perspective of a top handle assembly of a sled mold enclosure, in accordance with some of the embodiments of the disclosure provided herein; and,

FIG. 20 is an isometric perspective of a bottom ice mold of a sled mold enclosure as viewed from the bottom, in accordance with some of the embodiments of the disclosure provided herein.

### DETAILED DESCRIPTION

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

As described above, the present invention relates to a coasting device and particularly to such a device in the general form of a mold, pan or tray. The device is constructed and arranged for the purpose of sliding or riding either on snow, ice, sand, earth or on wood or metal floors or other structures.

The inventor of the present invention has recognized the shortcomings of the related art wherein, all other tangentially related products have a higher price point and are much more complicated.

Previous means of getting an ice block was finding an ice company to sell one. This invention lets you freeze the ice block at home. There are no other devices in the field. In order to find an ice block big enough to sit on and slide down a hill then you must buy one from an ice company.

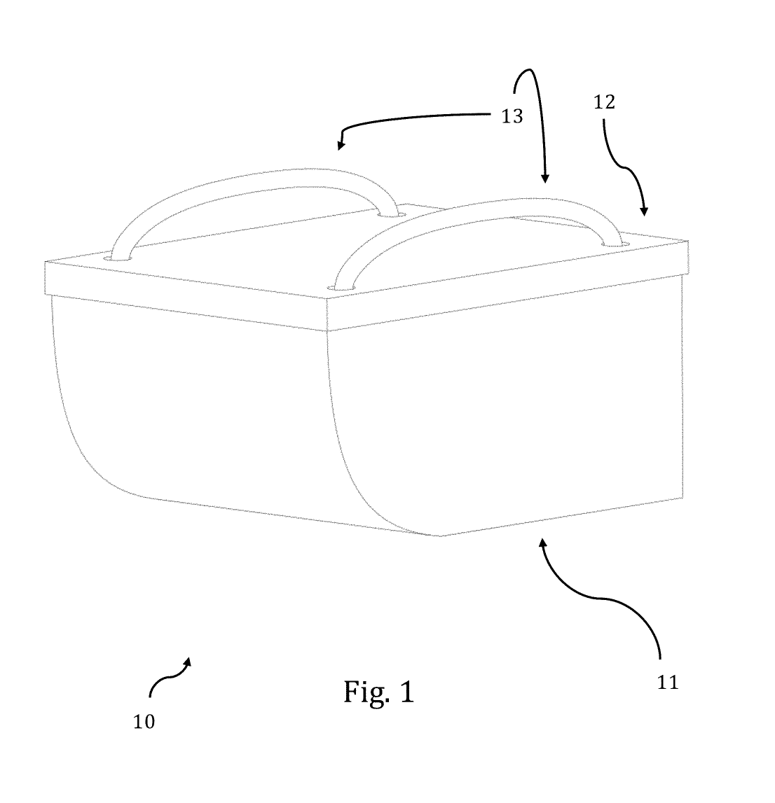

FIG. 1 is an isometric perspective of an exemplary sled mold enclosure 10, in accordance with some embodiments of the disclosure provided herein. Sled mold enclosure 10 comprises top handle assembly 12, handles 13 and bottom ice mold tray 11, all of which will be discussed in greater detail later in the disclosure.

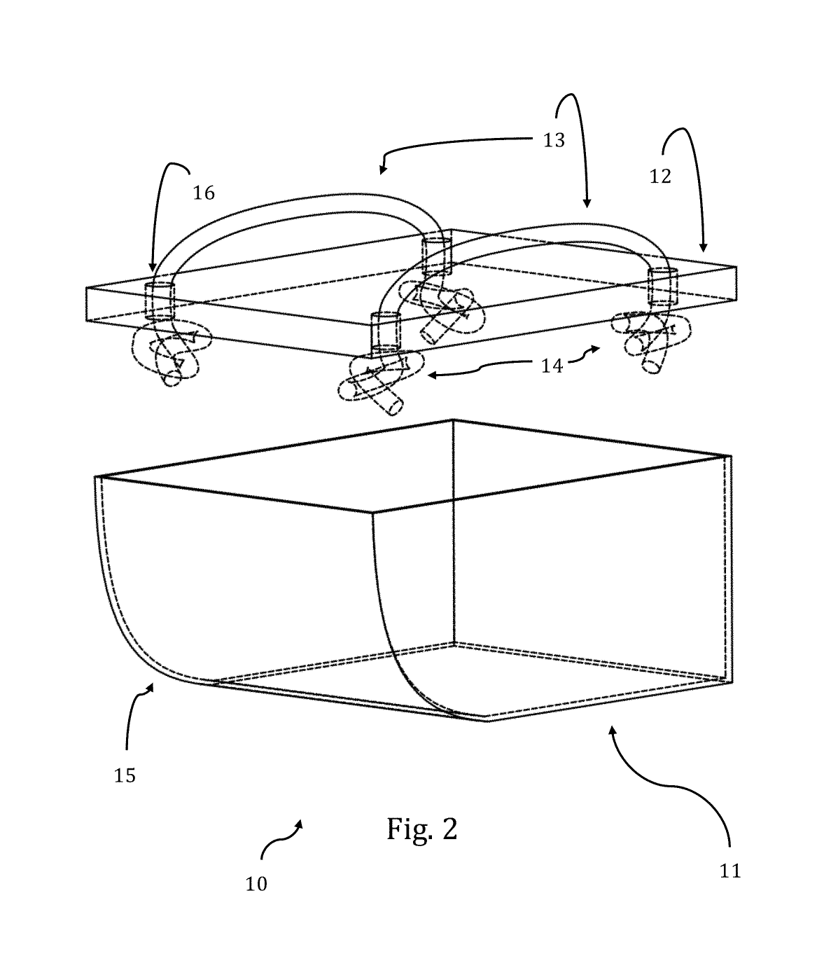

While FIG. 1 depicts an assembled view, FIG. 2 is an exploded, isometric perspective of an exemplary sled mold enclosure 10 comprising top handle assembly 12 and bottom ice mold tray 11, in accordance with some embodiments of the disclosure provided herein.

In one embodiment, bottom ice mold tray 11 is substantial rectangular. That is, in terms of three dimensions the shape of bottom ice mold tray 11 can be characterized as a cuboid, rhomboid or right rectangular prism with a sloping interface 15 (joint) of two sides. In some embodiments, the sloping interface 15 of two or more sides is generally round or parabolic; while in other embodiments, it may be beveled or chamfered. Additionally, other edges of the cuboid can be chambered, beveled, parabolic, elliptical or rounded with varying radii.

Bottom ice mold tray 11 is made from plastic, such as, Plexiglas or acrylic in the present embodiment. However, other rigid materials, particularly polymers, are not beyond the scope of the present invention. In practice, bottom ice tray mold 11 is filled with liquid (discussed later in the disclosure). Therefore, it is preferable to use materials which can be bonded and assembled to hold a small volume of fluid.

In one embodiment, top handle assembly 12 is sized substantially to mate with open face of bottom ice mold tray 11, and hence is also substantially rectangular. In the present embodiment, it is made from similar polymer material; however, other rigid materials, such as, aluminum or other suitable metals or composites, such as, carbon fiber, are not beyond the scope of the present invention.

In some embodiments, top handle assembly 12 comprises one or more handles 13 which are constructed by passing rope though holes or apertures 16 disposed in the top face. Apertures can be effected by drilling holes 16 through top face or simply engendered via voids in polymer extrusion mold. In the present embodiment, there are two handles 13 (see FIG. 2 et al.) and the apertures 16 are round/cylindrical. However, in other embodiments one or any plurality of handles 13 is possible, in addition to other aperture 16 shapes, such as, polyhedral, etc. Handles 13 are affixed using knots 14. These are other variations will be discussed in greater detail later in the disclosure.

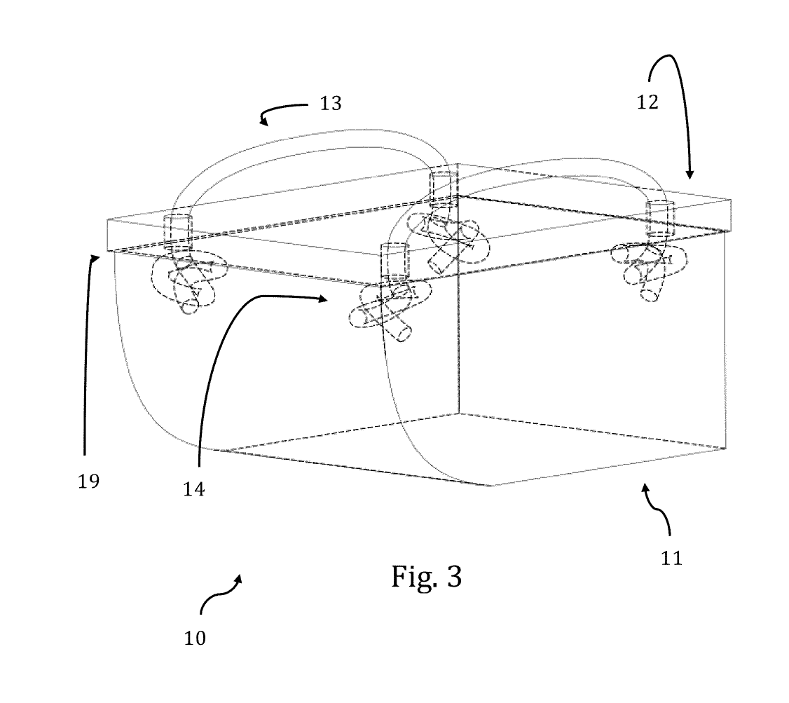

FIG. 3 is an isometric perspective of an exemplary sled mold enclosure 10 and bottom ice mold tray 11 depicting a transparent/cut-away view of internals thereof, in accordance with some embodiments of the disclosure provided herein. Turning to FIG. 3, bottom ice mold tray 12 is substantially filled with liquid in practice. In the present embodiment, the liquid is water, but other freezable liquids including solutions are not beyond the scope of the invention. In one embodiment, top handle assembly 12 exhibits a mating surface or edge 19, such as, a bevel which integrates with bottom ice mold tray 11 exhibiting a similar mating surface suitable for mating therewith.

In practice, bottom ice tray mold 11 is mated with top handle assembly 12, as depicted in FIG. 3, and placed in freezer. With respect to methodology, the freezer is disposed in a typical residential refrigerator unit according to the present embodiment. However, any device suitable to freeze the sled mold enclosure 10 can be used.

Knots 14 are tied in the ropes on the bottom of top handle assembly 12 to secure thereof. As can be appreciated by those in the art, the knots 14 of the ropes are immersed (i.e., submerged) in the liquid which subsequently freezes around them. The result secures top handle(s) 13 to bottom ice tray mold 11 giving rise to sled mold enclosure 10 with ice sled therein. Post freeze, top handle assembly 12 is used to lift and extricate ice sled from bottom ice mold tray 11.

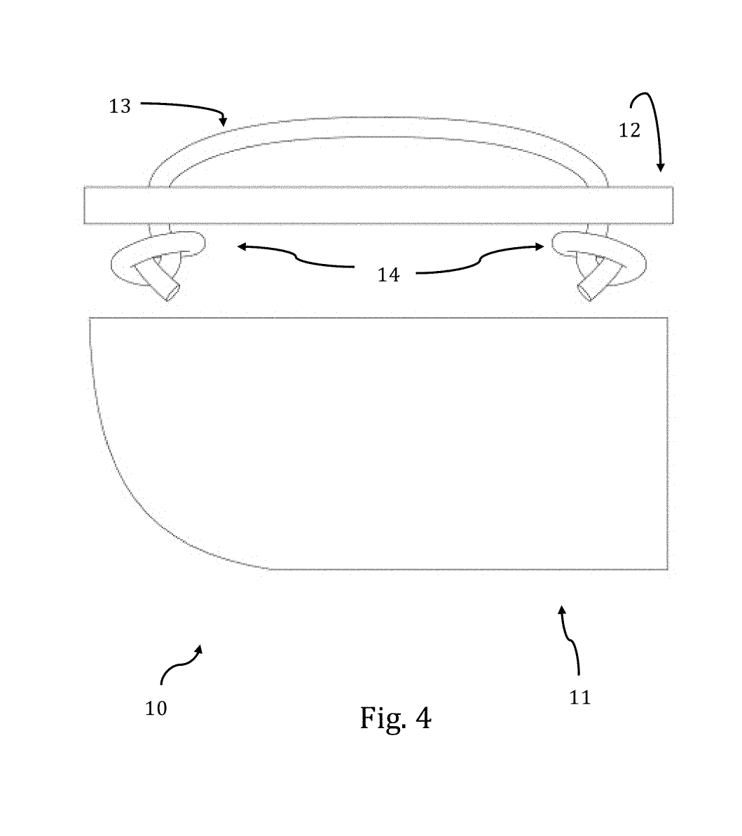

FIG. 4 is a disjointed, side-view of an exemplary sled mold enclosure 10, in accordance with some embodiments of the disclosure provided herein. In the present embodiment, the rope comprised by the handles 13 of the top handle assembly 12 is climbing rope. In other embodiments rope can be sailing rope, rubber hose, surgical tubing, hemp, metal chain, malleable wire, polymer tubing or any other suitable flexible material with minimal tensile strength. Knots 14 in any of the aforementioned are easily manipulated. However, other means of securement (discussed later in the disclosure) can be performed using less flexible materials and not beyond the scope of the present invention.

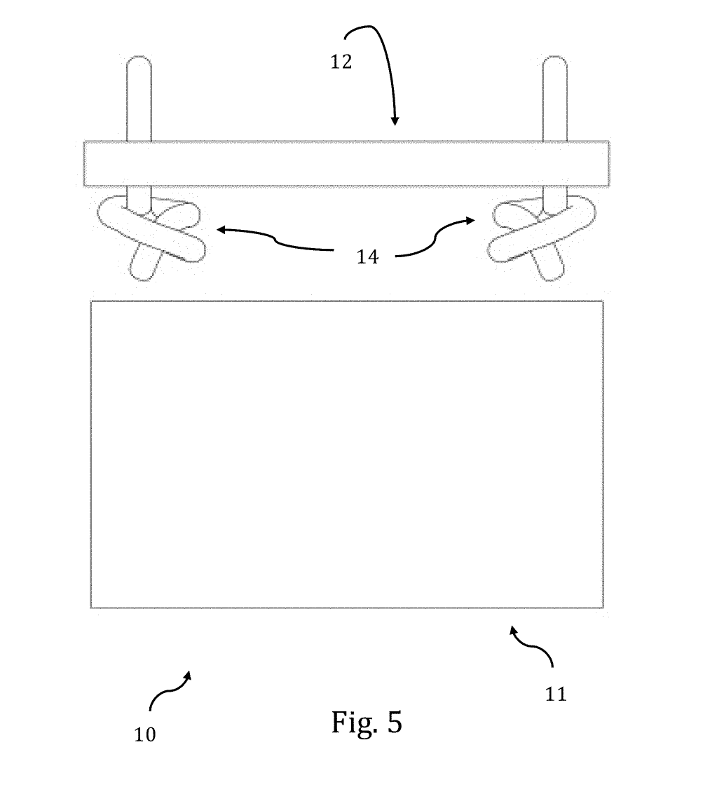

FIG. 5 is a disjointed, front view of an exemplary sled mold enclosure 10, in accordance with some embodiments of the disclosure provided herein. In the present embodiment, the ropes comprised in part by the top handle assembly 12 are tied using square knots 14. However, any suitable knot or crimp, such as, overhand, figure-eight, square, Becket, Carrick, bowline, clove hitch, timber hitch, tautline, or sheepshank can be used.

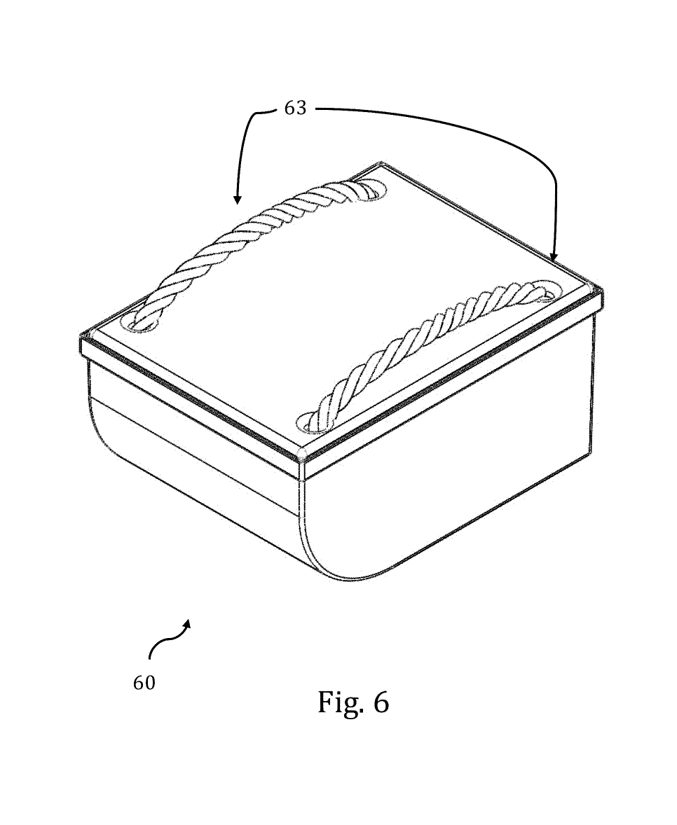

FIG. 6 is an isometric perspective of an exemplary sled mold enclosure 60, in accordance with one or more alternate embodiments of the disclosure provided herein. Depicted in FIG. 6, handles 63 are made of traditional hemp rope.

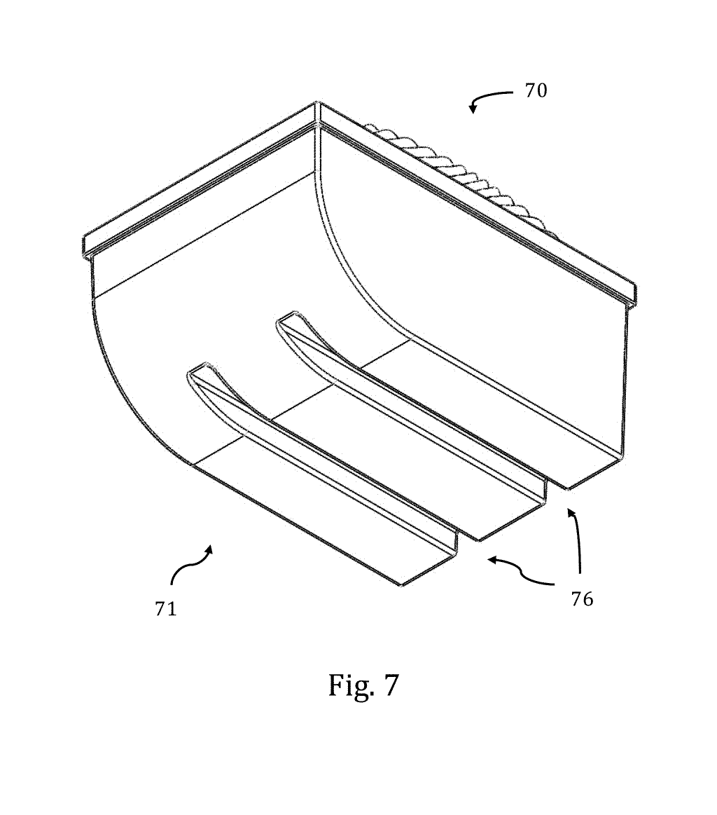

FIG. 7 is an isometric perspective of an exemplary sled mold enclosure 70 as viewed from the bottom, in accordance with one or more alternate embodiments of the disclosure provided herein. In this embodiment, the bottom ice mold tray 71 has two substantially linear reliefs 76 disposed therewithin. In practice, the reliefs 76 engender sipes in the ice sled which allows a user to maintain a more straight forward trajectory.

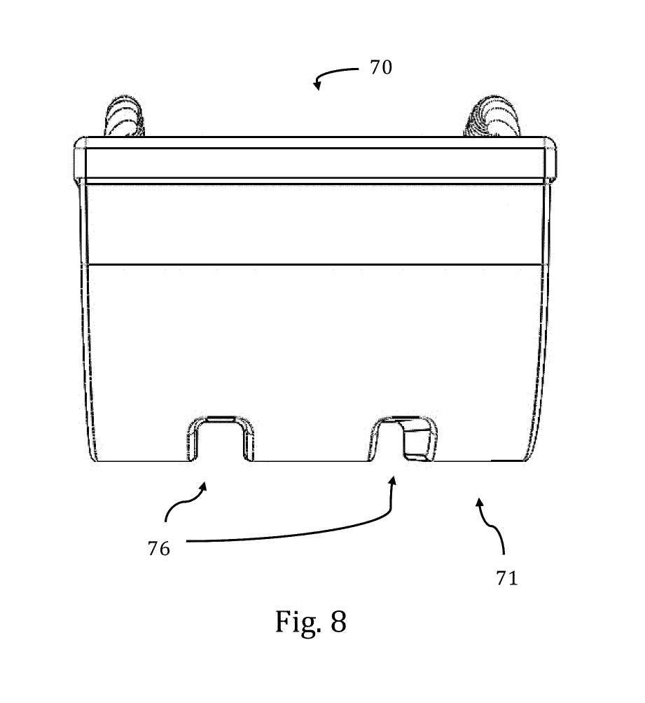

FIG. 8 is a front view of an exemplary sled mold enclosure 70 and bottom ice mold 71, in accordance with one or more alternate embodiments of the disclosure provided herein. FIG. 8 illustrates a relative scale for the linear reliefs 76. However, both the plurality and size/scale may be varied and remain within the scope of the present invention. In fact, the preferred embodiment yields no siping.

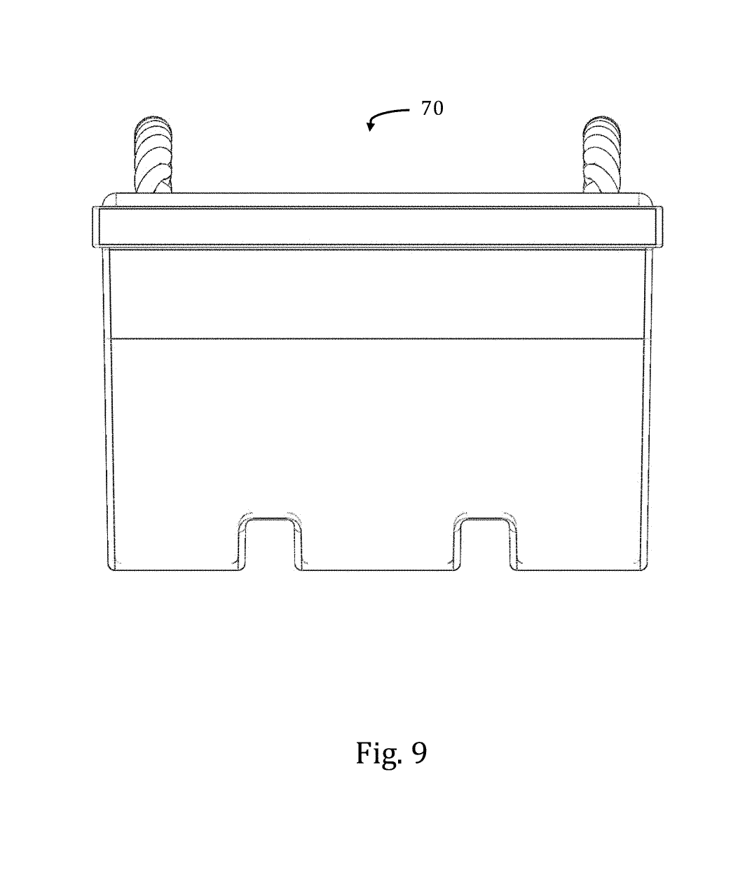

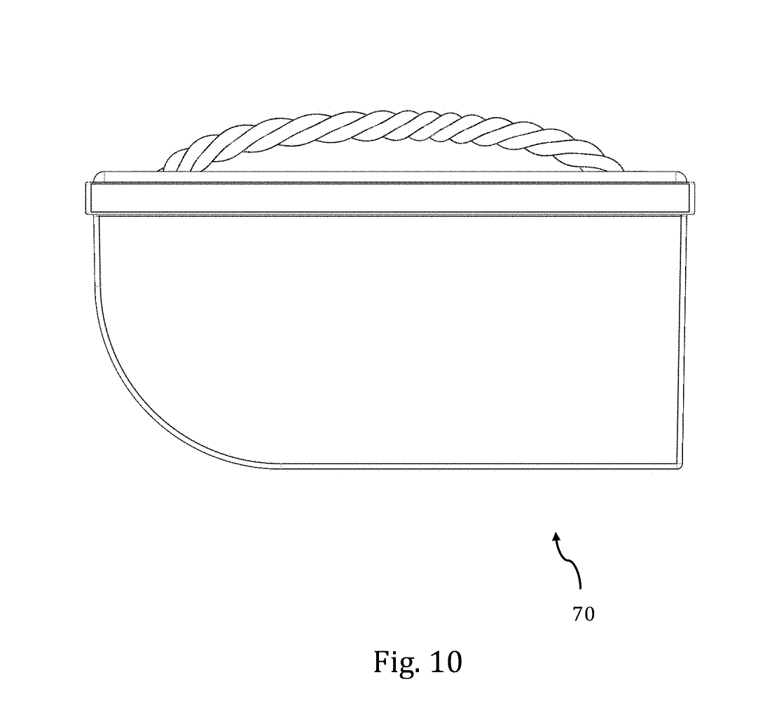

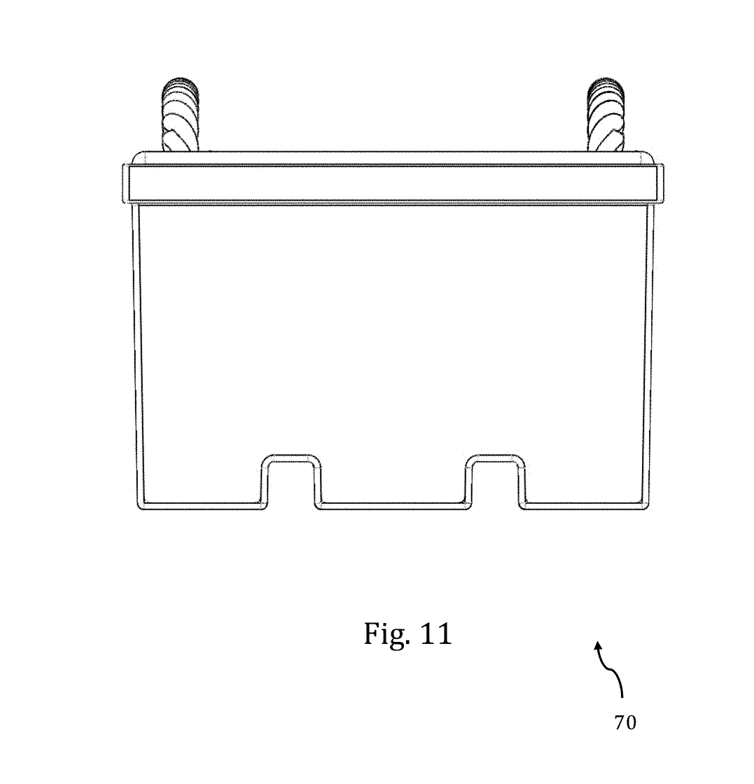

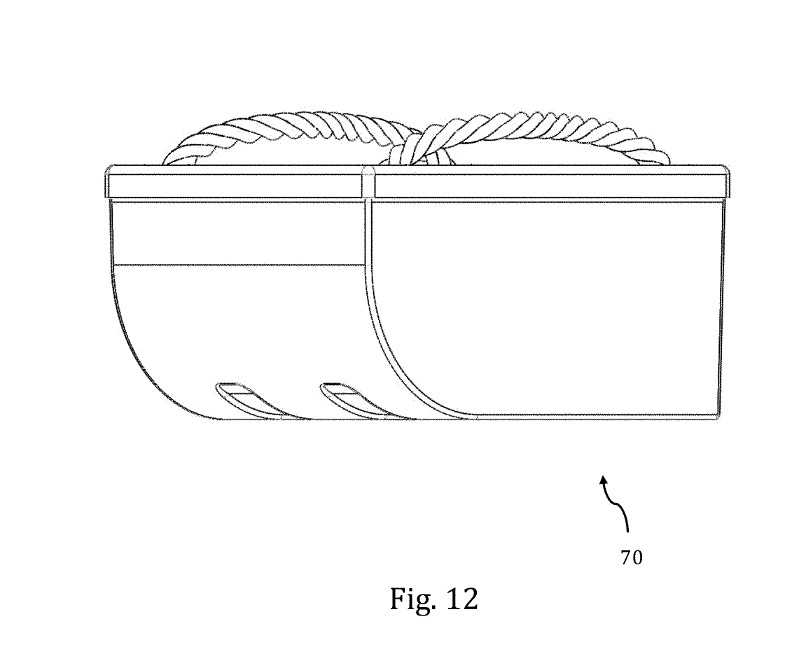

FIGS. 9-12 depict various views (front, side, rear, three-quarter) of an exemplary sled mold enclosure 70, in accordance with one or more alternate embodiments of the disclosure provided herein.

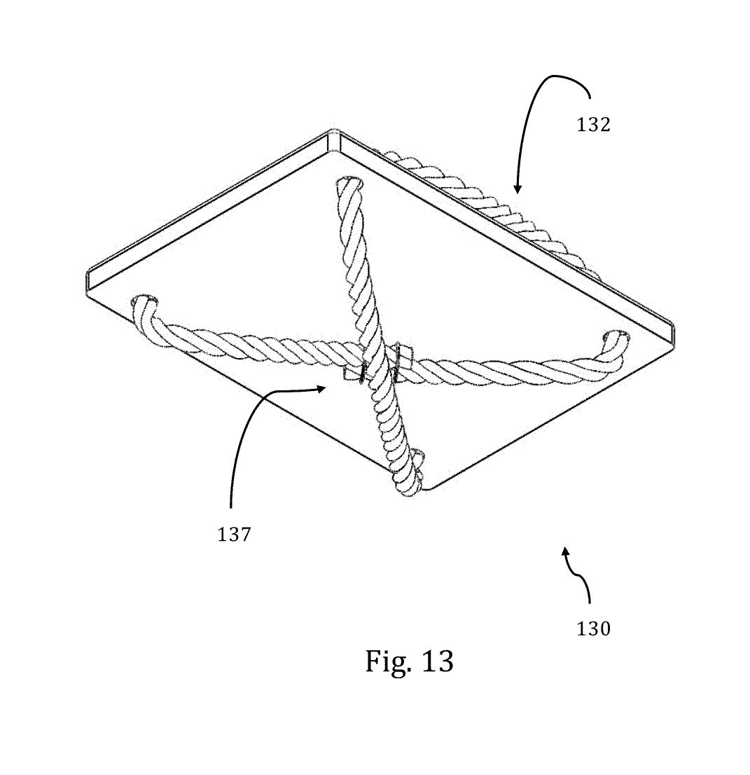

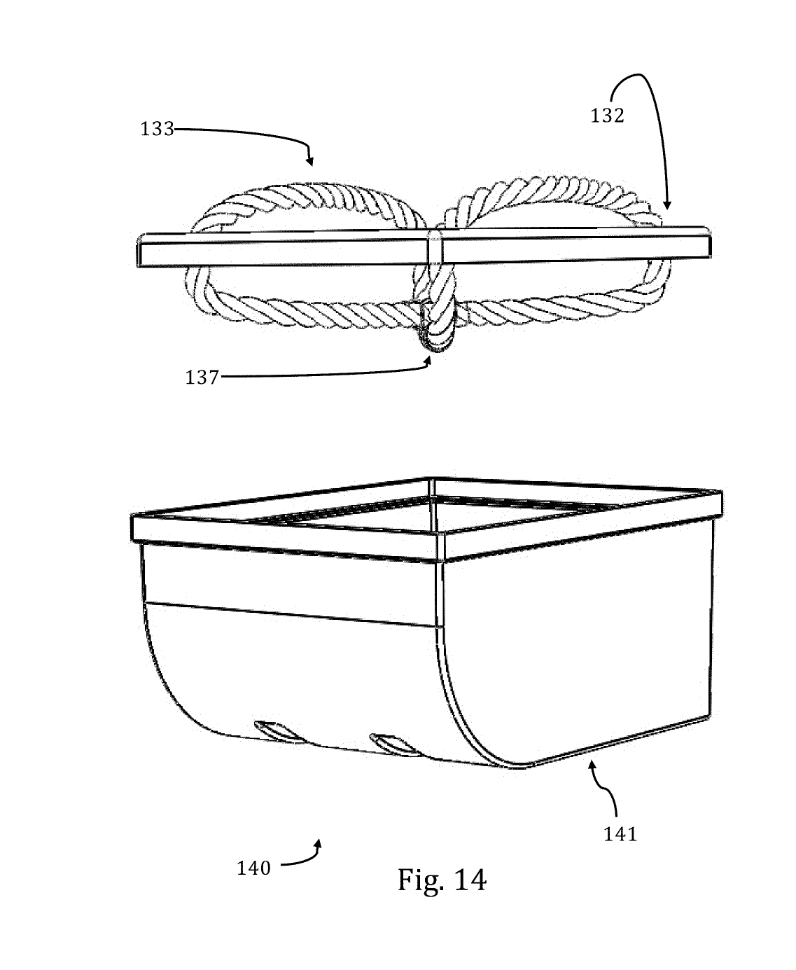

FIGS. 13-14 are isometric perspectives (both individual and exploded) of an exemplary top handle assembly 132 of a sled mold enclosure as viewed from the bottom, in accordance with one or more embodiments of the disclosure provided herein. As illustrated, ropes comprised by handles 133 are crimped 137 together in an “X” configuration. As can be appreciated by those in the art, a larger rope mass immersed and frozen in the volume of fluid in bottom ice mold tray 141 yields a more secure connection to top handle assembly 132. Other crimp 137 and knot configurations are not beyond the scope of the present invention.

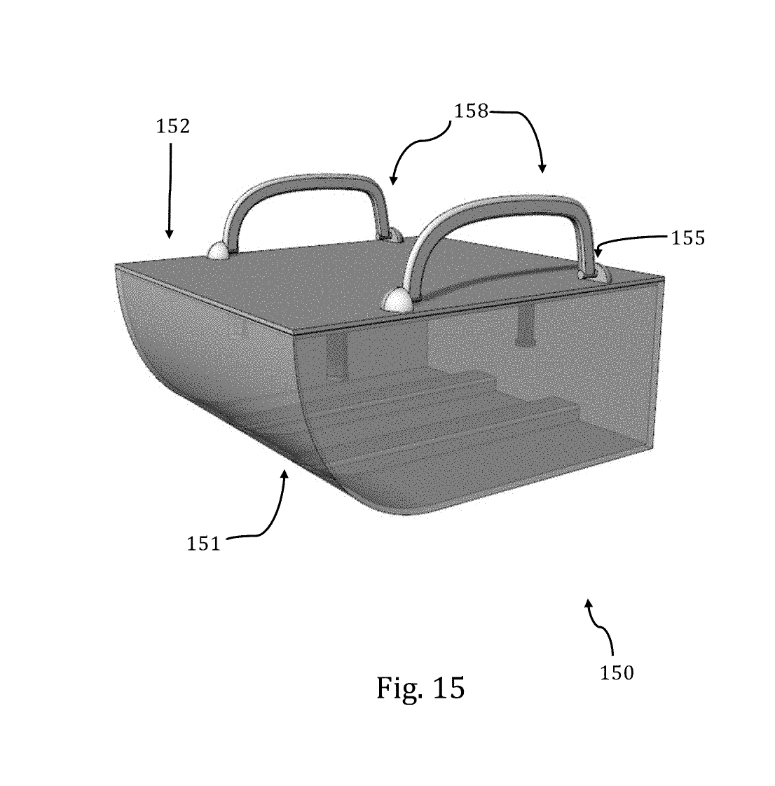

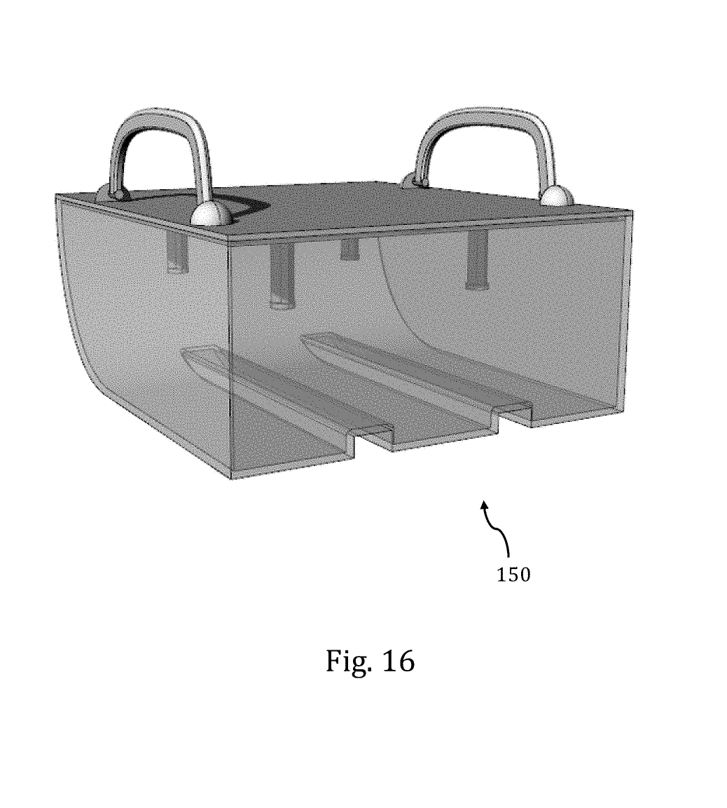

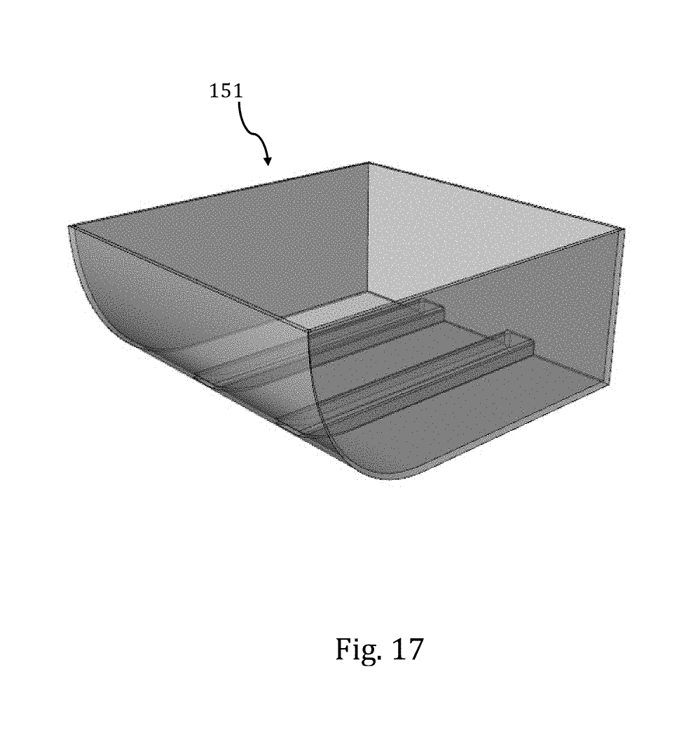

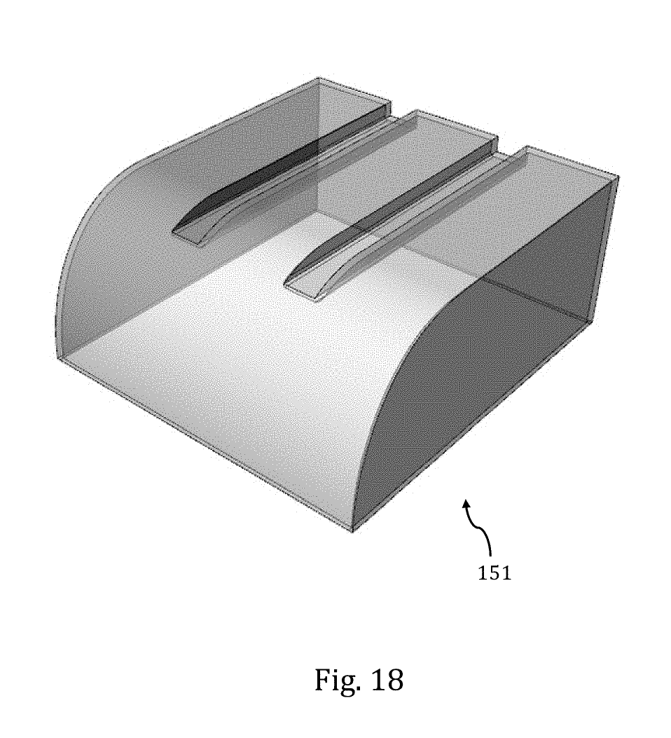

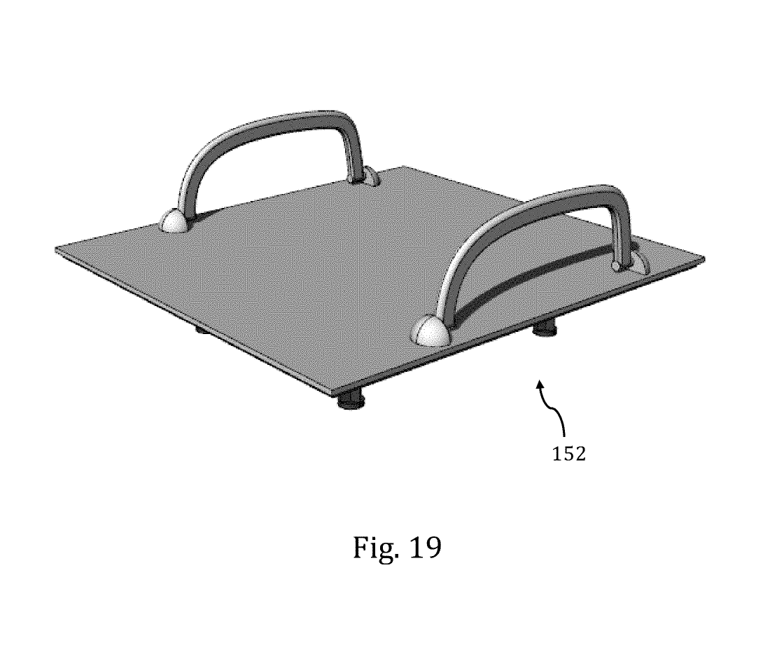

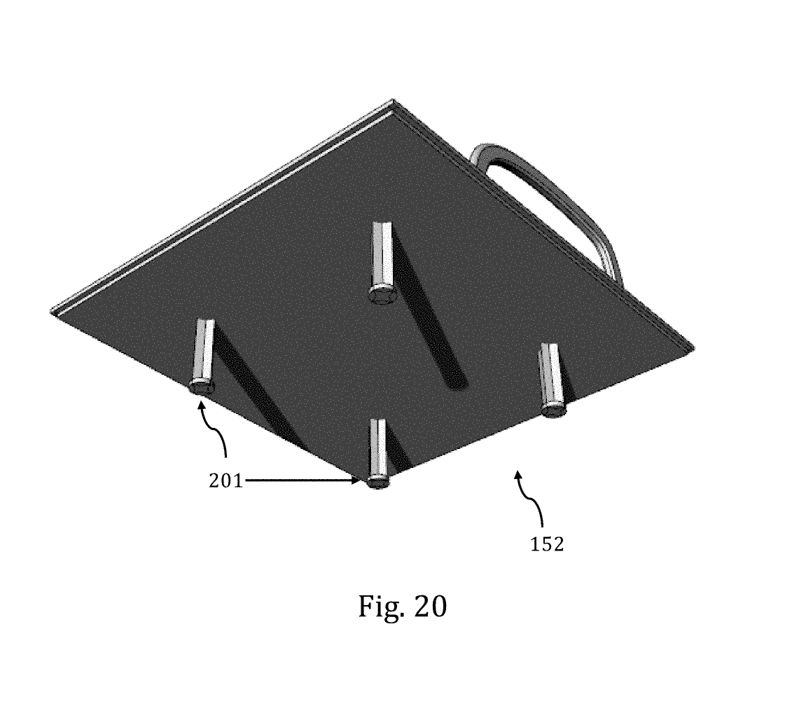

FIGS. 15-20 are an isometric perspectives (top, bottom, rear, upside-down, three-quarter et al.) of a sled mold enclosure 150, in accordance with alternate embodiments of the disclosure provided herein. Ice sled mold enclosure 150 comprises bottom ice tray mold 151 and top handle assembly 152. Pursuant to the present embodiment, one or more elements are fabricated from metal. Specifically, top handle assembly 152 and handles 158 are made of metal. Any suitable metal including alloys can be used to construct top handle assembly 152 and handles 158.

In the present embodiment, the handles 158 are rigidly affixed to the plane of the top handle assembly 152. The handles can also articulate around a pins 155 secured to the plane, like those found on suitcase. In lieu of rope knots, the present embodiment employs stanchions 201 with flattened tip at the distal end thereof. Akin to the knots, flattened tips prevent the top handle assembly from pulling out of the block of the ice sled.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. An ice sled enclosure comprising:
a bottom mold which has the capacity to hold a substantial amount of liquid; and,
a top handle assembly comprising one or more handles and a substantially planar lid;
wherein, said substantially planar lid has a similar perimeter dimension such that it mates with said bottom mold.

2. The ice sled enclosure of claim 1 further comprising a mating surface which integrates said bottom mold to said top handle assembly.

3. The ice sled enclosure of claim 2, wherein said mating surface is a bevel and integrates said bottom mold to said top handle assembly.

4. The ice sled enclosure of claim 1, wherein said bottom mold is made of a polymer.

5. The ice sled enclosure of claim 4, wherein said polymer is a plastic.

6. The ice sled enclosure of claim 1, wherein said one or more handles comprises rope.

7. The ice sled enclosure of claim 6, wherein said rope comprises hemp.

8. The ice sled enclosure of claim 6, wherein said rope comprises a polymer.

9. The ice sled enclosure of claim 8, wherein said polymer is nylon.

10. The ice sled enclosure of claim 6, wherein said top handle assembly further comprises one or more aperture through which said rope passes therethrough.

11. The ice sled enclosure of claim 10, wherein said rope is configured in a knot at respective distal end.

12. The ice sled enclosure of claim 10 further comprising a crimp which is disposed to secure said distal ends of rope which have passed through said on or more apertures.

13. The ice sled enclosure of claim 1, wherein said one or more handles comprises metal.

14. The ice sled enclosure of claim 1, wherein said planar lid comprises metal.

15. The ice sled enclosure of claim 1, wherein said bottom mold comprises metal.

16. The ice sled enclosure of claim 1, wherein said bottom mold further comprises relief sipes.

17. The ice sled enclosure of claim 1, wherein one side of said bottom mold is a rounded chamfer.

18. The ice sled enclosure of claim 1, wherein said ice sled enclosure is shaped substantially like a cuboid.

19. The ice sled enclosure of claim 1, wherein said one or more handles affix to said top handle assembly via hinges.

20. A method of making an recreational ice sled comprising the step of:
substantially filling a bottom mold with a volume of liquid, said bottom mold configured in a cuboid shape comprising five sides and a mating edge along the remaining open side;
integrating a top handle assembly with said mating edge, said top handle assembly comprises at least one handle;
freezing said integration of top handle assembly and bottom mold until liquid changes phases to a solid; and,
extricating said solid from said bottom mold;
whereby, at least some part of said top handle assembly has been frozen into said solid thereby creating a platform for said recreational ice sled.
